(19) United States
(12) Patent Application Publication
(10) Pub. No.: US 2003/0083847 A1
(43) Pub. Date: May 1, 2003

(54) User interface for presenting data for an intrusion protection system

(76) Inventors: Richard L. Schertz, Raleigh, NC (US); Craig D. Anderson, Chapel Hill, NC (US)

Correspondence Address: HEWLETT-PACKARD COMPANY, Intellectual Property Administration, P.O. Box 272400, Fort Collins, CO, 80527-2400, US

(21) Appl. No.: 10/002,694

(22) Filed: Oct. 31, 2001

(51) Int. Cl. G06F 11/30; G06F 15/00; G21C 17/00

(52) U.S. Cl. 702/186

(57) ABSTRACT

In accordance with the present invention, a method of presenting data related to an intrusion event on a computer system comprises the steps of capturing data related to the intrusion event and decoding the captured data from a predetermined format to a predetermined format decipherable by humans. The decoded data comprises intrusion event data, data summary, and detailed data. The method then presents the decoded data to a user.

### CROSS-REFERENCE TO RELATED APPLICATIONS

This patent application is related to co-pending U.S. Patent Application, Attorney Docket No. 10014010-1, entitled “METHOD AND COMPUTER READABLE MEDIUM FOR SUPPRESSING EXECUTION OF SIGNATURE FILE DIRECTIVES DURING A NETWORK EXPLOIT”; U.S. Patent Application, Attorney Docket No. 10016933-1, entitled “SYSTEM AND METHOD OF DEFINING THE SECURITY CONDITION OF A COMPUTER SYSTEM”; U.S. Patent Application, Attorney Docket No. 10017028-1, entitled “SYSTEM AND METHOD OF DEFINING THE SECURITY VULNERABILITIES OF A COMPUTER SYSTEM”; U.S. Patent Application, Attorney Docket No. 10017029-1, entitled “SYSTEM AND METHOD OF DEFINING UNAUTHORIZED INTRUSIONS ON A COMPUTER SYSTEM”; U.S. Patent Application, Attorney Docket No. 10017055-1, entitled “NETWORK INTRUSION DETECTION SYSTEM AND METHOD”; U.S. Patent Application, Attorney Docket No. 10016861-1, entitled “NODE, METHOD AND COMPUTER READABLE MEDIUM FOR INSERTING AN INTRUSION PREVENTION SYSTEM INTO A NETWORK STACK”; U.S. Patent Application, Attorney Docket No. 10016862-1, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO”; U.S. Patent Application, Attorney Docket No. 10016591-1, entitled “NETWORK, METHOD AND COMPUTER READABLE MEDIUM FOR DISTRIBUTED SECURITY UPDATES TO SELECT NODES ON A NETWORK”; U.S. Patent Application, Attomey Docket No. 10014006-1, entitled “METHOD, COMPUTER READABLE MEDIUM, AND NODE FOR A THREE-LAYERED INTRUSION PREVENTION SYSTEM FOR DETECTING NETWORK EXPLOITS”; U.S. Patent Application, Attorney Docket No. 10016864-1, entitled “SYSTEM AND METHOD OF AN OSINTEGRATED INTRUSION DETECTION AND ANTI-VIRUS SYSTEM”; U.S. Patent Application, Attorney Docket No. 10002019-1, entitled “METHOD, NODE AND COMPUTER READABLE MEDIUM FOR IDENTIFYING DATA IN A NETWORK EXPLOIT”; U.S. Patent Application, Attorney Docket No. 10017334-1, entitled “NODE, METHOD AND COMPUTER READABLE MEDIUM FOR OPTIMIZING PERFORMANCE OF SIGNATURE RULE MATCHING IN A NETWORK”; U.S. Patent Application, Attorney Docket No. 10017333-1, entitled “METHOD, NODE AND COMPUTER READABLE MEDIUM FOR PERFORMING MULTIPLE SIGNATURE MATCHING IN AN INTRUSION PREVENTION SYSTEM”; U.S. Patent Application, Attorney Docket No. 10017270-1, entitled “NODE AND MOBILE DEVICE FOR A MOBILE TELECOMMUNICATIONS NETWORK PROVIDING INTRUSION DETECTION”; U.S. Patent Application, Attorney Docket No. 10017331-1, entitled “METHOD AND COMPUTER-READABLE MEDIUM FOR INTEGRATING A DECODE ENGINE WITH AN INTRUSION DETECTION SYSTEM”; U.S. Patent Application, Attorney Docket No. 10017328-1, entitled “SYSTEM AND METHOD OF GRAPHICALLY DISPLAYING DATA FOR AN INTRUSION PROTECTION SYSTEM”; and U.S. Patent Application, Attorney Docket No. 10017303-1, entitled “SYSTEM AND METHOD OF GRAPHICALLY CORRELATING DATA FOR AN INTRUSION PROTECTION SYSTEM”.

### TECHNICAL FIELD OF THE INVENTION

This invention relates to computer systems and processes, and more particularly, to a user interface for presenting data for an intrusion protection system.

### BACKGROUND OF THE INVENTION

Network intrusion protection or detection systems monitor and analyze network traffic data to detect the occurrence of attacks on a computer system. Most conventional intrusion detection or protection systems generally do not log network traffic associated with an intrusion event and display only limited details of the relevant data packet. For example, such systems may only provide the source and destination Internet Protocol addresses of the relevant data packet. Other intrusion protection or detection systems require the use of a separate network monitoring applications, such as AGILENT TECHNOLOGIES' INTERNET ADVISOR and MICROSOFT'S NETWORK MONITOR, to decode the network traffic from binary packet data to a human-readable text format and/or a hexadecimal format. Therefore, it is generally cumbersome and time-consuming for a user to specify and manage a traffic data storage location, access the captured data, manually decode the data or call on a separate decode application, interpret and analyze the data, and then determine the best course of response or action.

### SUMMARY OF THE INVENTION

In accordance with the present invention, a method of presenting data related to an intrusion event on a computer system comprises the steps of capturing data related to the intrusion event and decoding the captured data from a predetermined format to a predetermined format decipherable by humans. The decoded data comprises intrusion event data, data summary, and detailed data. The method then presents the decoded data to a user.

In another embodiment of the present invention, a method of presenting data of an intrusion detection system comprises the steps of capturing, from a network, data related to an intrusion event in response to a trigger, storing the captured data, and decoding the captured data from a first predetermined format to a second predetermined format, where the decoded data comprises network header data, data summary, and detailed data. The method then presents the decoded data according to a predetermined report format.

In yet another embodiment of the present invention, a system of presenting data of an intrusion detection system comprises a network driver capturing data related to an intrusion event, a data storage device storing the captured data, and a decode engine decoding the captured data from a predetermined format to a predetermined format decipherable by humans, where the decoded data comprises intrusion event data, data summary, and detailed data. The system further comprises a user interface presenting the decoded data to a user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an intrusion protection system with a user interface system according to an embodiment of the present invention;

FIG. 2 is a more detailed block diagram of the intrusion protection system with a user interface system of FIG. 1;

FIG. 3 is a simplified flowchart of a method of providing a user interface for an intrusion protection system according to an embodiment of the present invention;

FIG. 4 is a more detailed flowchart of a method of providing a user interface for an intrusion protection system according to an embodiment of the present invention; and

FIG. 5 is an exemplary screen shot of an embodiment of the user interface system according to the teachings of the present invention.

### DETAILED DESCRIPTION OF THE DRAWINGS

The preferred embodiment of the present invention and its advantages are best understood by referring to FIGS. 1 through 5 of the drawings, like numerals being used for like and corresponding parts of the various drawings.

FIG. 1 is a simplified block diagram of a user interface system 10 for an intrusion protection system 14 according to an embodiment of the present invention.

A comprehensive intrusion protection system (IPS) 14 may employ networkbased, host-based and inline intrusion protection components, such as Hewlett-Packard Company's ATTACK DEFENDER. Network-based intrusion protection systems monitor traffic on a network 16, and are generally deployed at or near the network's entry point, such as a firewall (not shown). Network-based intrusion protection systems analyze data inbound from the Internet and collect network packets to compare against a database of various known attack signatures or bit patterns. An alert may be generated and transmitted to a management system that may perform a corrective action such as closing communications on a port of the firewall to prevent delivery of the identified packets into the network. User interface system 10 may comprise a report generator 11 and a graphical user interface (GUI) 12 that provides real-time on-screen status and control information as well as reports. A storage device or database (DB) 18 storing a variety of information is accessible by intrusion protection system 14. For example, attack signatures to be monitored, system vulnerabilities, reporting formats, etc. may be stored in database 18.

Network-based intrusion protection systems generally provide real-time, or near real-time, detection of attacks. Thus, protective actions may be executed before a targeted system is damaged. Furthermore, network-based intrusion protection systems are effective when implemented on slow communication links such as ISDN (Integrated Services Digital Network) or T1 Internet connections. Moreover, network-based intrusion protection systems are easy to deploy. Typically, network-based intrusion protection systems are placed at or near the boundary of the network being protected.

Host-based intrusion protection systems, also referred to as “log watchers,” typically detect intrusions by monitoring system logs. Generally, host-based intrusion systems reside on the system to be protected. Host-based intrusion protection systems generally generate fewer “false-positives,” or an incorrect diagnosis of an attack, than network-based intrusion protection systems. Additionally, host-based intrusion protection systems may detect intrusions at the application level, such as analysis of database engine access attempts and changes to system configurations. However, host-based intrusion protection systems generally cannot detect intrusions before the intrusion has taken place and thereby provide little assistance in preventing attacks. Host-based intrusion protection systems are not typically useful in preventing denial of service attacks because these attacks normally affect a system at the network driver card level. Furthermore, because host-based intrusion protection systems are designed to protect a particular host, many types of network-based attacks may not be detected because of its inability to monitor network traffic.

Inline intrusion protection systems comprise embedded intrusion protection capabilities into the protocol stack of the system being protected. Accordingly, all traffic received by and originating from the system will be monitored by the inline intrusion protection system. Inline intrusion protection systems overcome many of the inherent deficiencies of network-based intrusion protection systems. For example, inline intrusion protection systems are effective for monitoring traffic on high-speed networks. Inline intrusion protection systems are often more reliable than network-based intrusion protection systems because all traffic destined for a server having an inline intrusion protection system will pass through the intrusion protection layer of the protocol stack. Additionally, an attack may be prevented because an inline intrusion protection system may discard data identified as associated with an attack rather than pass the data to the application layer for processing. Moreover, an inline intrusion protection system may be effective in preventing attacks occurring on encrypted network links because inline intrusion protection systems may be embedded in the protocol stack at a layer where the data has been decrypted. Inline intrusion protection systems is also useful in detecting and eliminating a device from being used as an attack client in a distributed attack because outbound, as well as inbound, data is monitored thereby.

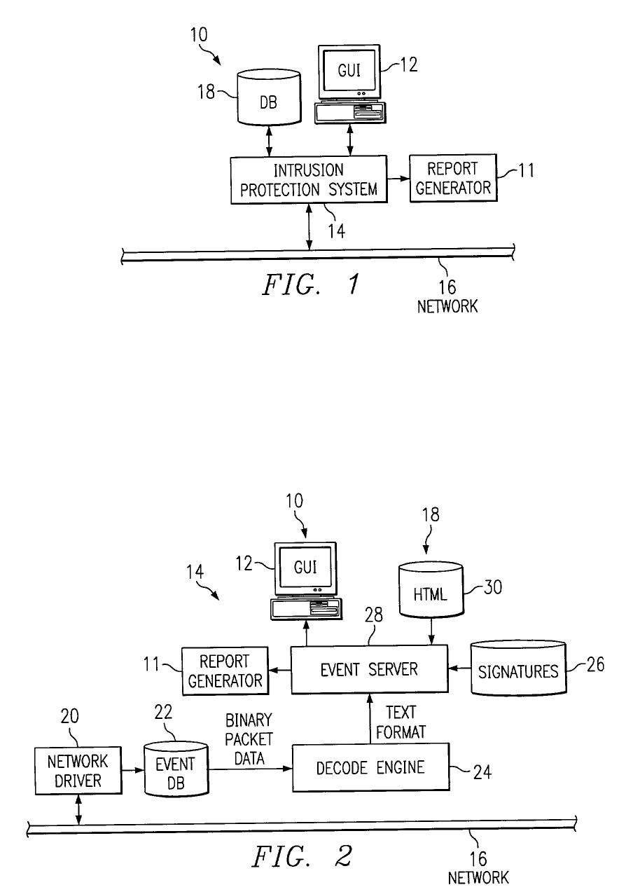

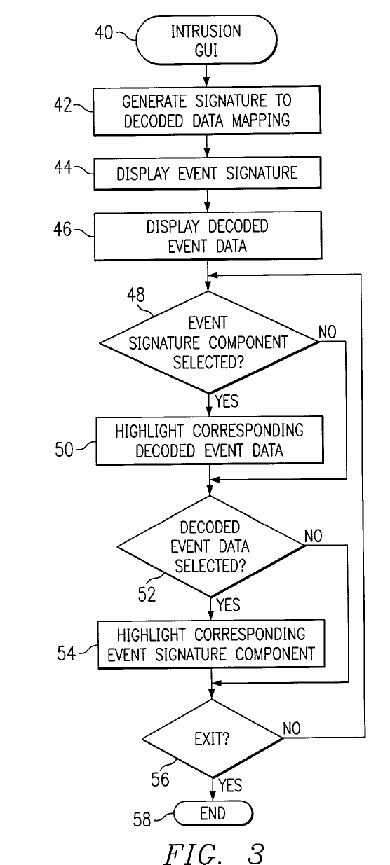

FIG. 2 is a more detailed functional block diagram of an intrusion protection system 14 with a user interface system 10 according to an embodiment of the present invention. A network driver 20 accesses the packet data traffic on network 16. Numerous network analysis tools exist and often employ various network capture and/or decode technologies. Network capture systems are responsible for reading and recording network traffic that may be valuable for network performance analysis, such as for performing an analysis of a network attack. Captured data may be viewed offline and, in some network capture systems, in real-time. Capture systems may employ pre-capture filters to reduce the amount of data that is captured by the capture system. “Triggers” may be employed that initiate or halt network capture. Exemplary triggers comprise pattern matching triggers, layer 2 and layer 3 errors such as checksum errors, and threshold triggers, such as latency triggers, that initiate capture of network traffic when a network transmission latency parameter falls below a predefined threshold. The captured network packet data may be selectively stored in an event database 22.

A protocol decode engine 24 is often utilized in conjunction with a network capture system and facilitates efficient analysis of the information obtained by the network capture system. Decode engine 24 is typically a software application that reads raw network data, such as binary streams captured off an Ethernet, and converts the captured data into a format suitable for viewing and analysis by a network manager or security personnel. Decode engine 24 is integrated within intrusion protection system 14 to simplify interpretation of intrusion-related network traffic. An exemplary three layered intrusion protection system 14 comprises an application service provider, a transport service provider and a network filter service provider is described in co-pending application entitled Method and Computer Readable Medium for a Three-Layered Intrusion Prevention System for Detecting Network Exploits [10014006-1], Serial No. _______, and a protocol decode engine integrated with an intrusion protection system is described in co-pending patent application entitled Method and Computer-Readable Medium for Integrating a Decode Engine with an Intrusion Detection System [10017331-1], Serial No. _______. As network driver 20 or another component of the intrusion protection system recognizes an attack, packet data associated with that intrusion event, or event data, are logged or stored in event database 22. Intrusion events are defined by a “signature” or a data pattern that may be used to identify a known attack. For example, a distributed attack commonly known as the “ping of death” has the telltale signature of particular series of bits in the ICMP (Internet Control Message Protocol) header and IP (Internet Protocol) header. This may be expressed as:

(icmp)&(65535<((ip[2:2]−((ip[0:1]0x0f)*4))+((ip[6:2]_0x1fff)*8))))

Event logging may comprise writing a copy of the network frame or packet identified in the intrusion event, reporting an indication of the signature file(s), such as a signature file identification index, determined to have a correspondence with the identified frame or packet, date and time of the event, indexing the event with an event number, as well as logging other intrusion event information. The signature definitions of known attacks are preferably stored in a database 26.

Decode engine 24 is capable of recognizing and decoding the binary packet data into header information of various transmission protocols, such as Ethernet header and IP header, and the information comprised therein. For example, destination and source addresses or identifiers, packet length, fragmentation information, etc. are decoded by decode engine 24. Decode engine 24 is preferably integrated into intrusion protection system 14. The decoded information is translated by decode engine 24 into a predetermined text format and representation that is decipherable by humans which is provided to an event server 28. For example, decode engine 24 may parse the binary packet stream and convert the data to ASCII with the proper labels for different parts of the header data. Event server 28 is a processor that receives the decoded data packet information, along with the signature definition associated with the event and supplies the information to user interface system 10. User interface system 10 comprises a graphical user interface 12, which is capable of displaying real-time status information as well as archived data.

In one embodiment of the present invention, the information to be displayed by graphical user interface 12 is displayed within HTML (hypertext markup language) templates, style sheets or other dynamic web display formats 30 using a web browser application, such as MICROSOFT INTERNET EXPLORER or NETSCAPE NAVIGATOR. By using HTML or some similar worldwide web (WWW) publishing format, the intrusion or audit information may be easily transmitted by a web server (not shown) and graphically displayed to a remote user for analysis or monitoring.

Although event data 22, HTML templates 30 and signature definitions 26 are shown in FIG. 2 as being stored in three separate databases or storage devices, such distinction may merely be functional and depend on implementation preferences.

FIG. 3 is a simplified flowchart of a method of providing a user interface 40 for an intrusion protection system according to an embodiment of the present invention. In block 42, decode engine 24 generates a signature-to-decoded data mapping table (not shown) that comprises the start and stop offsets of each fields into the signature strings of known attacks. Referring also to FIG. 5, an exemplary screen shot of an embodiment of the user interface system according to the teachings of the present invention is shown. The signature associated with the current intrusion event is displayed graphically 102 to the user, as shown in block 44. The decoded event data, such as Ethernet header summary 104 and IP header summary 106, and also the IP header data in hexadecimal format 108 are also displayed as shown in block 46. As shown in FIG. 5, data signature 102 may be displayed across the top of the graphical user interface display area, Ethernet header summary 104, IP header summary, and IP header data 108 are preferably displayed in an organized manner. A printed report with similar content and format may also be generated by report generator 11. Report generator 11 may request a plurality of data files regarding a plurality of intrusion-events stored in event database 22. A plurality of event data files obtained from event database 22 may then be submitted to decode engine 24 for interpretation thereof. Upon interpretation of the intrusion-events, the interpreted data representative of a plurality of events is submitted to report generator 11 where it may be compiled into a report documenting various aspects of the plurality of events. The report may also be archived in a report database (not explicitly shown but may be implemented in any of the databases 22, 26 or 30). A request for a report may specify a query for a report having information on events having common properties, such as a common type of attack. Other report queries may specify a request for any events occurring during a specified period of time. In general, a report query may comprise any query function that may be used to interrogate event database 22 and accordingly, may comprise report queries requesting a report containing event specific data, events resulting from network frame matches with one or more particular signature identifiers, events occurring during specified periods of time, specific event numbers, or a range of specific event numbers, as well as specifications of any other data that may be logged with event data in event database 22.

As the user is viewing the on-line data organized as shown in FIG. 5, he or she may click on and highlight certain data components 112 in the header summary 106 to cause the event data segment 114 corresponding to the user-highlighted data component 112 to also be highlighted, and vice versa. For example, highlighting ip[2:2] segment of the event signature causes the hexadecimal representation of the IP header packet data beginning at byte 2 for a length of 2 bytes (data segment 114 in FIG. 5) to also be highlighted. Furthermore, the IP header summary associated with the 2 bytes of data starting in byte 2 is also highlighted. This graphical correlation is achieved by consulting the mapping table generated in block 42 (FIG. 3) to determine the related data components. Furthermore, the component 110 of the data signature 102 that corresponds to the user-highlighted header data component 112 is also highlighted as a result. These steps are shown in blocks 48-56 in FIG. 3. It may be seen that although this functionality is shown in FIG. 3 as a sequential series of steps, the order in which the determination of whether the user selected a signature component, IP header summary, or IP header data is insignificant and can be performed in any order. The process ends in block 58.

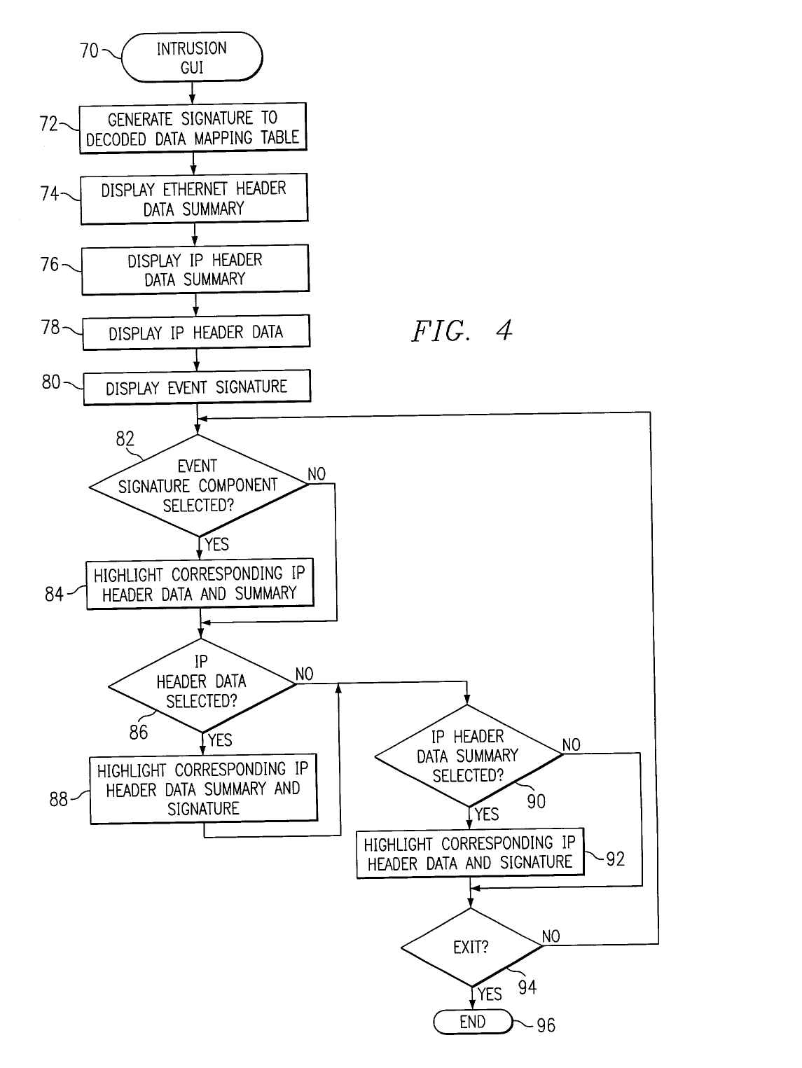

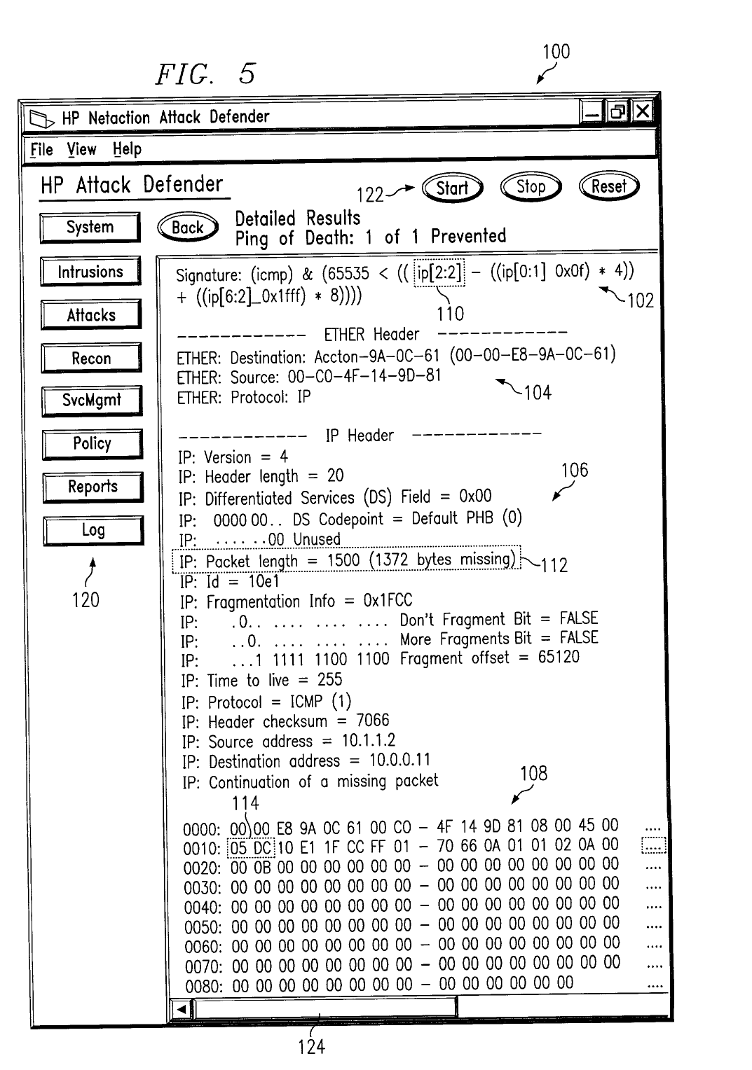

FIG. 4 is a more detailed flowchart of a method 70 of providing a user interface for an intrusion protection system according to an embodiment of the present invention. In block 72, a table that maps the components of the data signature to components or segments of the decoded event data is generated. The graphical user interface system then displays various categories of data that together provide information to a user who is interested in diagnosing a problem, monitoring current conditions, or analyzing a detected intrusion. In one embodiment, the event signature 102, the Ethernet header summary 104, the IP header 106, and event data 108 in hexadecimal format (all shown in FIG. 5) are displayed to the user in a clear and organized manner, as shown in blocks 74-80. The displayed data in each section are correlated to one another when the user highlights a header summary segment or signature component or IP data, as shown in blocks 82-92. The corresponding data in all the sections are highlighted when the user highlights a particular component of data. The graphical correlation is performed by accessing the mapping information in the signature-to-decoded data table. The process terminates in block 96 if the user chooses to exit in block 94.

FIG. 5 is an exemplary screen shot 100 of an embodiment of the user interface system according to the teachings of the present invention. A number of functional buttons 120 are shown organized vertically on the left side of the displayed screen. Functional buttons 120 may be used by the user to obtain various types of information for display as well as reporting. Another series of buttons 122 may be disposed across the top of the displayed screen to support general start, stop and reset commands of the auditing or intrusion detection process. A first section 102 of the main display screen shows the signature that corresponds to the detected event. A second section 104 displays a summary of the Ethernet header data. A third section 106 displays a summary of IP header data, and a fourth section 108 displays the captured event data in hexadecimal format. The aforementioned graphical correlation between the various signature segments, summary data components, and detailed data segments enables the user to more quickly assess the status and interpret the data. The user is able to see not only the actual data details, but also the meaning behind the data without having to manually decode the data and convert and interpret the hexadecimal representation of the data.

The design, format and organization of the graphical display shown in FIG. 5 are merely an exemplary way in which the present invention may be implemented. Further, other relevant data details or data summaries may also be displayed and correlated to other parts of the captured data. For example, other network layer protocol header data, such as ICMP (Internet Control Message Protocol) or IGMP (Internet Group Management Protocol) header data, or relevant data related to other protocol layers may be displayed and graphically correlated to one another.

What is claimed is:

1. A method of presenting data related to an intrusion event on a computer system, comprising:
capturing data related to the intrusion event;
decoding the captured data from a predetermined format to a predetermined format decipherable by humans, the decoded data in turn comprises intrusion event data, data summary, and detailed data; and
presenting the decoded data to a user in an organized manner.

2. The method, as set forth in claim 1, wherein capturing data comprises capturing network data packets of the intrusion event.

3. The method, as set forth in claim 1, wherein decoding the captured data comprises decoding the captured data from a binary format to a human-readable text format.

4. The method, as set forth in claim 1, wherein decoding the captured data comprises decoding the captured data to decoded data having a data link layer protocol header, a network layer protocol header, a network layer protocol data summary, and packet data in hexadecimal format.

5. The method, as set forth in claim 1, wherein decoding the captured data comprises decoding the captured data to decoded data having an Ethernet header, an IP header, an IP data summary, and packet data in hexadecimal format.

6. The method, as set forth in claim 1, wherein presenting the decoded data comprises displaying the decoded data on a computer screen.

7. The method, as set forth in claim 1, wherein presenting the decoded data comprises graphically displaying the decoded data according to a predetermined report organization and format.

8. The method, as set forth in claim 1, wherein presenting the decoded data comprises generating a report having the decoded data.

9. A method of presenting data of an intrusion detection system, comprising:
capturing, from a network, data related to an intrusion event in response to a trigger;
decoding the captured data from a first predetermined format to a second predetermined format, the decoded data comprising network header data, data summary, and detailed data; and
presenting the decoded data according to a predetermined report format.

10. The method, as set forth in claim 9, wherein capturing data comprises capturing network data packets of the intrusion event in response to detecting the presence of a predetermined signature in the network data packet.

11. The method, as set forth in claim 9, wherein decoding the captured data comprises decoding the captured data from a binary format to a human-readable text format.

12. The method, as set forth in claim 9, wherein decoding the captured data comprises decoding the captured data to decoded data having a data link layer protocol header, a network layer protocol header, a network layer protocol data summary, and packet data in hexadecimal format.

13. The method, as set forth in claim 9, wherein decoding the captured data comprises decoding the captured data to decoded data having an Ethernet header, an IP header, an IP data summary, and packet data in hexadecimal format.

14. The method, as set forth in claim 9, wherein presenting the decoded data comprises graphically displaying the decoded data according to a predetermined report format and organization.

15. The method, as set forth in claim 1, wherein presenting the decoded data comprises generating a report having the decoded data.

16. A system of presenting data of an intrusion detection system, comprising:
a network driver capturing data related to an intrusion event from a network;
a decode engine decoding the captured data from a predetermined format to a predetermined format decipherable by humans, the decoded data comprising intrusion event data, data summary, and detailed data; and
a user interface presenting the decoded data to a user.

17. The system, as set forth in claim 16, wherein the network driver captures network data packets of the intrusion event in response to the intrusion detection system detecting a predetermined intrusion signature.

18. The system, as set forth in claim 16, wherein the decode engine decodes the captured data from a binary format to a human-readable text format.

19. The system, as set forth in claim 16, wherein the decode engine decodes the captured data to decoded data having a data link layer protocol header, a network layer protocol header, a network layer protocol data summary, and packet data in hexadecimal format.

20. The system, as set forth in claim 16, wherein the decode engine decodes the captured data to decoded data having an Ethernet header, an IP header, an IP data summary, and packet data in hexadecimal format.

21. The system, as set forth in claim 16, wherein the user interface displays the decoded data on a computer screen.

22. The system, as set forth in claim 16, wherein the user interface graphically displaying the decoded data according to a predetermined report organization and format.

23. The system, as set forth in claim 16, wherein the user interface generates a report having the decoded data.
